(19) United States
(12) Patent Application Publication
(10) Pub. No.: US 2006/0266367 A1
(43) Pub. Date: Nov. 30, 2006

(54) Nasal dilator

(75) Inventor: Louis Noce, Sanford, FL (US)

Correspondence Address: NIXON & VANDERHYE, PC, 901 NORTH GLEBE ROAD, 11TH FLOOR, ARLINGTON, VA, 22203, US

(73) Assignee: Alisa A. Noce, Sanford, FL (US)

(21) Appl. No.: 11/230,650

(22) Filed: Sep. 21, 2005

Related U.S. Application Data
(63) Continuation-in-part of application No. 11/138,310, filed on May 27, 2005.

(51) Int. Cl. A62B 7/00; A62B 7/10; A62B 23/02

(52) U.S. Cl. 128/207.18; 128/206.11; 128/205.29; 128/205.11; 128/205.25; 128/205.27; 128/206.12; 128/206.18; 128/206.21; 128/207.13; 128/204.12; 128/200.24; 128/201.25

(57) ABSTRACT

A nose dilation device includes a resilient one-piece plastic body including a generally U-shaped center portion and a pair of substantially horizontally oriented dilation rings extending outwardly from an upper end of the center portion and adapted to internally engage nasal passages of a user.

This is a continuation-in-part of application Ser. No. 11/138,310, filed May 27, 2005.

### BACKGROUND OF THE INVENTION

This invention relates to nasal dilation devices and, more particularly, to a flexible resilient dilator to be inserted inside the nasal passages.

The lower portion of the nostrils, immediately above the entrance to the nostrils, is known as the vestibule. The vestibule tapers inwardly to a narrow neck-like area called the ostium internum. Above the ostium internum, the nasal passages widen out. Nasal obstructions commonly occur at the ostium in individuals who have swelling due to allergic reactions, deviated septums, or similar conditions, to the point that the ostium may be substantially blocked.

Blockage of the nasal passages is particularly uncomfortable at night, since many people who have such problems breath through their mouths while sleeping. In particular, sustained mouth breathing over a long period of time may cause throat and lung irritation.

Nasal dilation devices designed to improve nasal breathing are well represented in the patent literature and are generally of two types. One type is externally applied and adhered on opposite sides of the nose to continually apply pulling forces to open the nasal passages. See, for example, U.S. Pat. Nos. 6,769,429; 6,375,667; 6,196,228; 6,098,616; 6,058,931; 6,029,658; 5,957,126; 5,718,224; 5,706,800; 5,653,224; 5,611,334; 5,611,333; and Re. 35,408. External nasal dilators, however, can cause general discomfort, skin irritation and discoloration.

A second type of nasal dilator is designed to be inserted into the nose and to push outwardly to open the nasal passages. See, for example, U.S. patent application Publication Nos. US2003/0181941 A1; US2003/0144684 A1; and U.S. Pat. No. 5,816,241. These devices may require adjustment and can also cause irritation and discomfort.

There remains a need, therefore, for a simple, inexpensive nasal dilator that is effective without causing irritation or discomfort, and which is simple in construction, easy to use and inexpensive to manufacture.

### BRIEF DESCRIPTION OF THE INVENTION

The present invention relates to a nasal dilator that is constructed of a non-invasive, flexible and resilient plastic material. The dilator may be of one-piece design and is insertable and self-supporting within the nose where it exerts a gentle, outwardly-directed spring action to open the nasal passages to thereby increase the volume of air flow through the nose.

The nasal dilators as described herein prevent outer raw tissue of the nasal passages of the nose from drawing in during breathing. The nasal dilators generally comprise a clip or center bridge and a pair of closed-periphery dilator rings. When in place, the dilator rings rest at the ostium within the nostrils, preventing the tissue from being drawn inwardly during inhalation and thus reducing air flow resistance.

In one exemplary embodiment, the nasal dilator includes a molded plastic body having a generally V-shaped center portion and a pair of substantially horizontally oriented dilation rings extending outwardly from the upper ends of the center portion. The base of the center portion is formed with an enlarged bulbous, or rounded clamp portion that is adapted to bridge the user's septum. Angled support arms extend between the rounded clamp portion and the horizontal dilator rings. The rounded clamp portion and the angled support arms are sized and shaped to permit resilient compression of the support arms to facilitate insertion of the dilator into the user's nostrils. When the support arms are released, the dilator will expand outwardly such that the horizontal dilation rings will apply light opening pressure on the nasal passages, while the interface of the support arms and the rounded clamp portion will engage the septum and maintain the dilator in position.

In another embodiment, the dilator has a substantially U-shaped center portion, and the support arms angle toward each other in a direction toward the dilator rings. In addition, the dilator rings are substantially pear-shaped to provide a more natural fit within the nasal cavity. A projection on the bridge portion of the dilator provides a gripping surface for facilitating insertion and removal of the dilator.

The dilator rings allow air to flow through and around the device, and radiused corners at every direction-change-location on the device minimize if not eliminate irritation and thus increase the overall level of comfort. In addition, the resilient nature of the plastic material permits self-adjustment of the dilator after insertion into the nose and release of the support arms.

Accordingly, in one aspect, the invention relates to a nose dilation device comprising a resilient one-piece plastic body including a generally U-shaped center portion and a pair of dilation rings extending outwardly from an upper end of the center portion and adapted to internally engage nasal passages of a user.

In another aspect, the invention relates to a nose dilation device comprising a resilient one-piece plastic body including a generally U-shaped center portion and a pair of dilation elements extending outwardly from an upper end of the center portion and adapted to internally engage a user's nasal passage; and wherein a base of the substantially U-shaped center portion includes a rounded clamp portion adapted to externally bridge the user's septum, and further wherein the U-shaped center portion also includes a pair of support arms extending between the rounded clamp portion and the dilation elements.

In still another aspect, the invention relates to a nose dilation device comprising a septum bridge, a pair of support arms extending upwardly from the septum bridge and a non-circular but closed-periphery dilation element extending substantially horizontally from each support arm, wherein the support arms are resiliently compressible about the bridge to permit insertion of the support arms and the dilation elements into a user's nostrils, and resiliently expandable once inside the nostrils to open the user's nasal passages.

The invention will now be described in connection with the drawings identified below.

### BRIEF DESCRIPTION OF THE DRAWINGS

FIG. 1 is a perspective view of a first exemplary embodiment of the nasal dilator;

FIG. 2 is a front elevation of the dilator shown in FIG. 1;

FIG. 3 is a top plan view of the dilator shown in FIGS. 1 and 2;

FIG. 4 is an end view of the dilator shown in FIG. 3;

FIG. 5 is an enlarged detail taken from FIG. 4; and

FIG. 6 is a perspective view of a second exemplary embodiment of the nasal dilator;

FIG. 7 is a is a front elevation of the dilator shown in FIG. 6

FIG. 8 is a is a top plan view of the dilator shown in FIGS. 6 and 7; and

FIG. 9 is an end view of the dilator shown in FIG. 8.

### DETAILED DESCRIPTION OF THE INVENTION

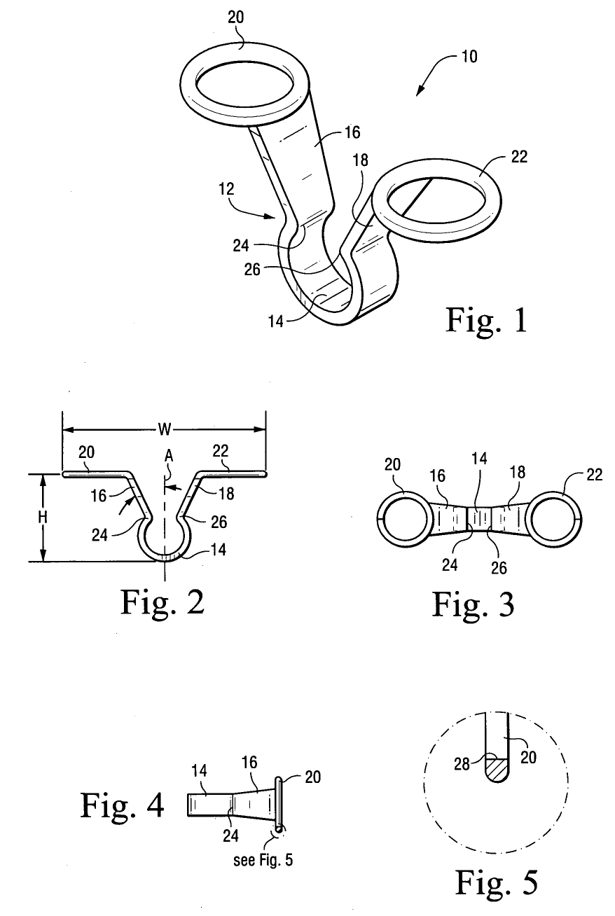

With reference to FIGS. 1-5, the nasal dilator device 10 (or simply, nasal dilator) in accordance with an exemplary embodiment, is a one-piece resilient plastic device. Nylon is especially suitable but other plastics may be effective as well. It includes a generally V-shaped center portion 12 that has a rounded or bulbous clamp portion (or septum bridge) 14 and a pair of angled support arms 16, 18 extending upwardly and outwardly therefrom. A pair of annular dilation or dilator rings 20, 22 extend substantially horizontally away from the upper ends of the respective support arms. Generally, the device may have a height H of about 0.5±0.005 in. and a width W of about 1.125±0.005 in. (see FIG. 2).

The rounded and partially annular clamp portion 14 has a curvature based on a diameter of 0.218±0.005 in., and extends about 150° where opposite ends connect at radiused interfaces 24, 26 with the support arms 16, 18, respectively. At the interfaces 24, 26, the support arms are spaced 0.125±0.005 in. from each other. The arms 16, 18 extend at about a 15° angle relative to a vertical center axis A through the device (FIG. 2). The clamp portion 14 and support arms 16, 18 have a generally rectangular cross-sectional profile as best appreciated in FIGS. 2, 3 and 4. The annular dilator rings 20, 22 each have a diameter of 0.25±0.005 in. and may have a generally round cross section. FIG. 5 illustrates a partially round cross section with a flat inner side 28 that may also be employed. The device may have a substantially uniform thickness of about 0.0312±0.005 in.

It will be appreciated that the flexible resiliency of the plastic material combined with the rounded clamp portion 14 allow the support arms to be squeezed or compressed inwardly to facilitate insertion of the device into the nose, with the clamp portion 14 externally bridging the septum. Once in place, the support arms 16, 18 are released to allow the dilator rings 20, 22 to spring outwardly to exert gentle opening pressure on the nasal passages. The resiliency and configuration of the dilator is such that the dilator rings self-adjust against the nasal passage tissue, and it will be appreciated that the dilator rings may be under about 50% compression when in place, i.e., the outward expansion of the dilator rings may be at about 50% of their unconstrained expansion.

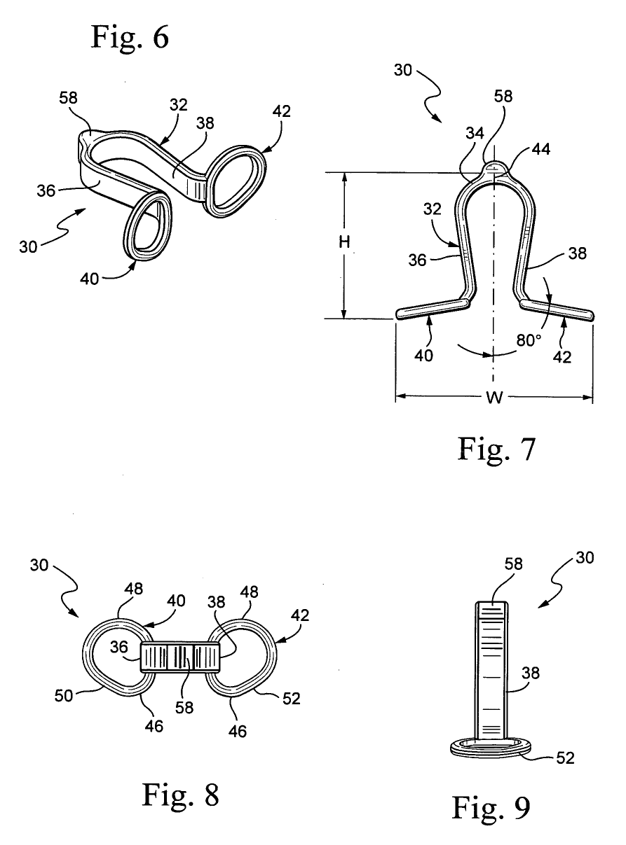

With reference now to FIGS. 6-9, a nasal dilator 30 in accordance with a second exemplary embodiment of the invention is, again, a one piece resilient plastic device constructed of nylon or other suitable plastic material. In this embodiment, the dilator includes a generally U-shaped center portion 32 that has a rounded clamp portion (or septum bridge) 34 and a pair of support arms 36, 38 extending upwardly therefrom. Unlike the embodiment described above, the resilient support arms 36, 38 angle toward each other as they extend away from the rounded base 34 toward the dilation or dilator rings 40, 42. The latter extend substantially horizontally away from the upper ends of the respective support arms. In this regard, and as shown in FIG. 7, the dilator rings 40, 42 define an angle of about 80° relative to a vertical center axis 44. The rings have closed peripheries but they are not circular in shape. Rather, they are generally pear-shaped, made up of multiple radii as apparent from FIG. 8. More specifically, the rings have smaller radiused portions 46 proximate the support arms, expanding outwardly and upwardly (as viewed in FIG. 8) to larger radiused portions 48, giving the rings their pear shape.

Note that the shape produces flat surfaces 50, 52 adjacent the smaller radiused portion 46. Some users may find the device more comfortable if inserted with the larger radiused portions 48 on top (FIGS. 6, 8) while others may find it more comfortable if inverted. Transition bends 54, 56 where the support arms meet the dilator rings 40, 42 provide an additional comfort feature, and as in the previously described embodiment, all corners and transition areas are radiused.

In this second exemplary embodiment, the smaller radiused portion 46 may have a radius of 0.078 inch and the larger radiused portion 48 may have a radius of 0.125 inch. The width W of the device in a relaxed state may be 0.917±0.005 or about 0.90 inch, and the height H may be about 0.70±0.005 inch. The wall thickness may be on the order of 0.045 inch. As viewed on FIG. 7, the angle between the support arms in the relaxed state is about 16-17° (for example, about 16.8°), the space between the support arms at the base of the dilator rings may be about 0.182 inch; and the width of each dilator ring is about 0.345 inch.

The rounded base 34 is also formed with a projection 58 which provides a good gripping surface for the user during insertion or removal of the dilator.

The nasal dilators as described herein provide effective stabilization at the ostium and provide effective relief from nasal blockage during inhalation without discomfort to the wearer.

It will also be appreciated that the dilators 10 and 30 as described herein may be manufactured in different sizes, with commensurate dimensional variations in the various portions of the devices, to accommodate a wider cross-section of users.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A nose dilation device comprising:
a resilient one-piece plastic body including a generally U-shaped center portion and a pair of dilation rings extending outwardly from an upper end of said center portion and adapted to internally engage nasal passages of a user.

2. The device of claim 1 wherein a base of said substantially U-shaped center portion includes a rounded clamp portion adapted to externally bridge a user's septum, said rounded clamp portion formed with a gripping projection facilitating insertion and removal of the device.

3. The device of claim 2 wherein said U-shaped center portion also includes a pair of support arms extending between said rounded clamp portion and said dilation rings.

4. The device of claim 1 wherein each of said horizontally oriented dilation rings is substantially pear-shaped.

5. The device of claim 3 wherein said support arms extend at an angle of about 16-17° relative to each other.

6. The device of claim 2 wherein said rounded clamp portion is formed with a gripping projection to facilitate insertion and removal of the device.

7. The device of claim 3 wherein said support arms angle toward each other in a direction toward said dilation rings.

8. The device of claim 1 wherein said body has a thickness of about 0.045 inch.

9. The device of claim 1 wherein said body has a width of about 0.917±0.005 in.

10. The device of claim 1 wherein said body has a height of about 0.70±0.005 in.

11. The device of claim 1 wherein said plastic comprises nylon.

12. A nose dilation device comprising:
a resilient one-piece plastic body including a generally U-shaped center portion and a pair of dilation elements extending outwardly from an upper end of said center portion and adapted to internally engage a user's nasal passage; and wherein a base of said substantially U-shaped center portion includes a rounded clamp portion adapted to externally bridge the user's septum, and further wherein said U-shaped center portion also includes a pair of support arms extending between said rounded clamp portion and said dilation elements.

13. The device of claim 12 wherein said support arms extend at an angle of about 16-17° relative to each other.

14. The device of claim 12 wherein said rounded clamp portion is formed with a gripping projection to facilitate insertion and removal of the device.

15. The device of claim 12 wherein said support arms angle toward each other in a direction toward said dilation rings.

16. The device of claim 12 wherein said dilation rings are substantially pear-shaped.

17. The device of claim 16 wherein said dilation rings each have a relatively smaller radiused portion and a relatively larger radiused portion connected on one side by a flat portion.

18. The device of claim 12 wherein said dilation rings extend substantially perpendicularly from said support arms.

19. The device of claim 12 wherein said resilient plastic comprises nylon.

20. A nose dilation device comprising:
a septum bridge, a pair of support arms extending upwardly from said septum bridge and a non-circular but closed-periphery dilation element extending substantially horizontally from each support arm, wherein said support arms are resiliently compressible about said bridge to permit insertion of said support arms and said dilation elements into a user's nostrils, and resiliently expandable once inside the nostrils to open the user's nasal passages.
